(19) United States
(12) Patent Application Publication
(10) Pub. No.: US 2018/0060467 A1
(43) Pub. Date: Mar. 1, 2018

(54) METHOD FOR SIMULATING A COLLISION SITUATION

(71) Applicant: dSPACE digital signal processing and control engineering GmbH, Paderborn (DE)

(72) Inventors: Sebastian SCHULTE, Meppen (DE); Frank Schuette, Warburg (DE); Rainer FRANKE, Borchen (DE); Martin KLUSTRACH, Paderborn (DE)

(73) Assignee: dSPACE digital signal processing and control engineering GmbH, Paderborn (DE)

(21) Appl. No.: 15/690,788

(22) Filed: Aug. 30, 2017

(30) Foreign Application Priority Data
Aug. 30, 2016 (DE) 10 2016 116 135.7

(51) Int. Cl. G06F 17/50

(52) U.S. Cl. CPC G06F 17/5009; B60W 2050/0031

(57) ABSTRACT

A method for simulating a collision situation between two vehicles for testing a driver assistance system in a driving simulator or in a Vehicle-in-the-Loop scenario. A fellow vehicle simulated on a simulation computer is assigned a trajectory that passes through a point of collision of a planned collision between the fellow vehicle and an ego vehicle that is not controlled by the simulation computer. The driver assistance system is equipped to exchange data with the simulated environment in real time and to influence the driving behavior of the ego vehicle in a collision situation. A target distance to the point of collision is determined for the fellow vehicle that the fellow vehicle would have to have in order to arrive at the point of collision simultaneously or substantially simultaneously with the ego vehicle, under the assumption that it travels at the specified arrival speed.

This nonprovisional application claims priority under 35 U.S.C. §119(a) to German Patent Application No. 10 2016 116 135.7, which was filed in Germany on Aug. 30, 2016, and which is herein incorporated by reference.

### BACKGROUND OF THE INVENTION

### Field of the Invention

The invention relates to a method for simulating a collision situation between two vehicles for testing a driver assistance system, in particular a driver assistance system designed as a motor vehicle control unit.

### Description of the Background Art

A variety of implementations of driver assistance systems are known in the prior art. For example, there are driver assistance systems for preventing accidents or for mitigating the consequences of accidents, such as, e.g., emergency braking assist systems. Such assistance systems are designed to detect a collision situation with another vehicle and to react to it in a manner stored in programming or circuitry. One example is to preload brake cylinders with hydraulic pressure even before a driver reaction that typically is initiated later or even to automatically carry out braking.

A driver assistance system can also be understood in the present case to be a system that controls a vehicle completely independently, without human intervention. Driver assistance systems of this nature are also referred to as an autopilot.

Generally speaking, a driver assistance system in the meaning of the invention is understood to be systems that are carried in a motor vehicle through implementation in software and/or hardware in a data processing system and that are equipped to intervene in the piloting of the vehicle by a human or even to take full control on an ongoing basis, or at least for a period of time, as a function of sensor measurement results.

Such a system can be implemented as an electronic control unit that has inputs and/or outputs for data and/or signals, for example to acquire sensor data from external sensors (e.g., distance sensors, such as ultrasonic or radar sensors) through the inputs and/or to transmit data or signals through outputs to external actuators or other control units, e.g. to a brake control unit.

Assistance systems of this nature require extensive testing to verify error-free operation prior to their actual use on public roads.

For testing control units, it is generally known to perform “VEHIL” tests, or so-called Vehicle-in-the-Loop tests. In such a test, a real vehicle in which the control unit under test is installed is driven on a test track, wherein the vehicle carries a simulation computer that enriches the actual test drive with virtual events or elements. To this end, the simulation computer sends to the control unit data or signals that would be present if an actual event or element were to occur. The control unit under test thus perceives the event or element as real, whereupon a reaction to it takes place during the real test drive. Among other things, the invention also concerns a VEHIL test of this nature in which the control unit under test is a driver assistance system.

In the simulation of a collision situation, the problem arises of ensuring that two vehicles reliably get into the desired collision situation that is to undergo testing. Yet with respect to the invention, no actual collision between two real vehicles is to be produced here, but rather at least one of the two vehicles, the vehicle hereinafter referred to as the fellow vehicle, is to be a vehicle simulated by a simulation computer in a simulation environment that performs a simulated drive, which is to say the travel of this fellow vehicle is simulated in another vehicle, which hereinafter is referred to as an ego vehicle, in particular in order to test the reaction of the driver assistance system installed in this ego vehicle to the upcoming collision situation in the simulation environment.

The concrete technical problem here is that the ego vehicle performs travel that is not deterministic from the viewpoint of the other simulated vehicle (fellow vehicle), which is to say travel that is not reliably predictable in advance, and consequently the simulation computer that simulates the travel of the fellow vehicle does not know in advance how it will have to control the fellow vehicle for the desired collision situation to arise with the ego vehicle.

In the case in which the ego vehicle is controlled by a human as a real vehicle such as, e.g., in the VEHIL testing mentioned above or as a vehicle that is likewise simulated, the travel is unpredictable inasmuch as it is impossible to predict which steering, braking, or acceleration maneuvers or other actions the human will perform as he approaches the point of collision, even when the path he is to drive is specified to the human. This applies equally when the ego vehicle is not a real vehicle but is likewise a simulated vehicle, although with the travel of the simulated ego vehicle again being controlled by a human, for example in a driving simulator.

Also in the case in which the ego vehicle as a real or simulated vehicle is controlled by an autopilot implemented in software and/or hardware, its travel is not calculable in advance for the fellow vehicle, since the fellow vehicle, or the simulation computer simulating this fellow vehicle's travel, does not have and cannot have advance knowledge of the constantly changing travel of the ego vehicle, since the autopilot system is completely independent of the control of the fellow vehicle, as would likewise be the case in reality.

A collision situation in the meaning of the invention is understood in any case to mean that, when traveling in the given manner, the two vehicles, the ego vehicle and the fellow vehicle, meet in simulated fashion at the point of collision, or in other words collide virtually.

However, a collision situation can also be understood to mean a “near-collision,” in which the two vehicles do not collide but approach one another closely enough along the given travel trajectories that the approach should trigger a reaction of the driver assistance system under test.

Thus, point of collision is understood hereinafter as at least the location on the trajectory of the ego vehicle where the two vehicles virtually meet at the same time, or in other words collide. The point of collision is also understood as the point at a distance from the ego vehicle where the fellow vehicle is located in order to correspond to the desired situation under test (near-collision).

When the trajectories of the two vehicles intersect, the point of collision can be the point of intersection in both situations, in particular wherein for the situation of the “near-collision” the fellow vehicle is located at the point of intersection and the ego vehicle is a distance from the point of intersection, in particular the distance at which the reaction of the driver assistance system is to be tested, or, if the vehicles continue to approach one another hereafter, the distance starting at which the reaction of the driver assistance system is to be tested.

### SUMMARY OF THE INVENTION

It is therefore an object of the invention to ensure that, in a virtual environment that is simulated in an ego vehicle by the simulation computer, a simulated fellow vehicle converges with the ego vehicle at a point of collision with a desired speed as a function of the specific travel of the ego vehicle.

According to an exemplary embodiment of the invention, an object is attained by the means that, in an environment simulated by a simulation computer, the simulated travel of the simulated fellow vehicle is calculated iteratively as a function of driving parameters of the travel of the ego vehicle. Driving parameters here are can be driving parameters of the ego vehicle acquired by measurement using sensors. Such sensors may, for example, be located on a real ego vehicle or on a driving simulator that generates driving parameters for simulation of the ego vehicle.

The invention can provide that a simulated fellow vehicle is assigned a trajectory on which the fellow vehicle moves and which passes through a point of collision of a planned collision between the fellow vehicle and an ego vehicle, wherein the driver assistance system is equipped to exchange data with the simulated environment and thus with the simulation computer, in particular in real time.

Real time can be understood to mean the operation of a simulation computer wherein programs for processing incoming data are always ready for operation such that the processing results are available within a specified period of time. Depending on the application, the data may arise in a random time distribution or at predetermined points in time. For example, the hardware and software ensure that no delays occur that could prevent this condition from being met. It is not necessary here for the processing of the data to be particularly fast in general, but only for it to be guaranteed to be fast enough for the simulation application in question.

With respect to the simulation of an environment, the real-time capability of the simulation computer ensures that the program or the data processing runs (nearly) simultaneously with the corresponding processes in reality.

In this context, the driver assistance system, which can be implemented as a control unit, is equipped to influence the driving behavior of the ego vehicle in a collision situation, in particular to perform a braking maneuver or an evasive maneuver.

In this process, an arrival speed is specified to the fellow vehicle at which it arrives, or at least should arrive, at the point of collision. Thus, the collision situation is defined through the point of collision and the speed of the fellow vehicle, in particular also the speed of the ego vehicle and, for example, also its position and, in particular, its distance from the point of collision, and can in particular also be stored using these parameters in the simulation environment, or in the simulation computer, for the purpose of computing the simulation. Particularly the speed and/or the position of the ego vehicle can be a driving parameter that is transmitted to the simulation computer in order to calculate the iterative simulation of the travel of the fellow vehicle.

An embodiment of the invention provides that the position of the ego vehicle traveling under control, in particular the distance to the point of collision and the current speed of the ego vehicle traveling under control, more particularly under the unpredictable control of, e.g., a human or autopilot, is determined cyclically for each cycle. Although the travel of the ego vehicle is not deterministically predicted for the future by this means, the travel segment traversed in each cycle can enter into the control of the fellow vehicle with the aid of the said parameters, so that according to the invention the travel of the fellow vehicle in the simulation can in effect be adapted to the travel of the ego vehicle after the fact, in particular with the goal that the fellow vehicle has the desired parameters describing the collision situation when it reaches the point of collision, for example, at the point of collision at the specified speed when the ego vehicle is in a specified position, in particular is a specified distance from the point of collision, in particular the distance zero.

According to an embodiment of the invention this is accomplished for each cycle, in particular by the simulation computer for the fellow vehicle, in such a manner that a target position, in particular a target distance, is calculated that the fellow vehicle would have to have relative to the point of collision in order to arrive at the point of collision at a desired time, in particular simultaneously with the ego vehicle, under the assumption that it travels at the specified arrival speed.

This target position or this target distance of the fellow vehicle is specified to a control loop that governs the position of the fellow vehicle along the trajectory, wherein the difference between the actual position and the target position or between the actual distance to the point of collision and the target distance is reduced by the control loop, in particular by changing the speed of the fellow vehicle. This reduction can take place in the next cycle as compared to the previous cycle in which the target distance was determined.

The control loop can be implemented in software on the simulation computer, in particular which is carried in a real ego vehicle in a preferred embodiment. The control loop can be incorporated into a higher-level control loop in which the current position (in the cycle under consideration) of the fellow vehicle is fed back in order to determine the speed to be specified for the fellow vehicle that is a function thereof.

The determination of the target position of the fellow vehicle or of the target distance of the fellow vehicle from the point of collision as a function of the arrival speed normally ensures that the fellow vehicle does indeed have the specified arrival speed when reaching the point of collision. If this should not be the case, but also in general, provision can be made that the speed of the fellow vehicle is set by force in the simulation computer to the arrival speed upon reaching the point of collision or in a spatial vicinity before the point of collision or a temporal vicinity before reaching the point of collision.

In the aforesaid control of the simulated travel of the fellow vehicle, provision can be made in one possible variant that the change in the speed and/or position of the fellow vehicle is carried out in each of the cycles under the assumption that the fellow vehicle has the mass zero. This ensures that the fellow vehicle can react arbitrarily quickly to the control actions of a human driving the ego vehicle in the real world or in the driving simulator.

This also achieves the result that the fellow vehicle is likewise located at the point of collision and has the specified arrival speed when the ego vehicle arrives at the point of collision. The control can make provision in this context that the actual position achieved in the driving simulation in the iteration cycle is simply corrected to the target position or the actual distance to the point of collision is simply corrected to the target distance to the point of collision, which means that the vehicle can accelerate arbitrarily fast and can travel at an arbitrarily high speed. For example, after this “setting to the target position” the travel can be continued such that it is simulated with the arrival speed, in particular until the position determination of the ego vehicle takes place again in the next cycle.

It can be problematic or undesirable in this type of control that the simulated fellow vehicle does not exhibit realistic physical driving behavior. Importance may be attached to this in the testing of driver assistance systems, however, in order to generate approaches of the fellow vehicle to the point of collision that are consistent with reality, which is to say, therefore, realistic occurrence of the collision situation.

In order to achieve this, the change in position of the fellow vehicle can occur dynamically through a change in the speed of the fellow vehicle in accordance with a dynamic mathematical model that takes real vehicle dynamics into account, in particular takes into account a vehicle mass and an acceleration capability of the fellow vehicle. Such a model can be used in the simulation computer to calculate the travel of the fellow vehicle in order to regulate the speed of the fellow vehicle. As a result, the fellow vehicle has realistic physical acceleration and braking behavior. In other words, an attempt is made to reduce the difference between the actual position of the fellow vehicle and the target position or the actual distance and the target distance to the point of collision by acceleration or braking.

The determination of the position of the ego vehicle or of the distance of the ego vehicle to the point of collision can be made in a simple embodiment by measuring the length of the straight line between the ego vehicle and the point of collision. Even though the actual distance in the case of a curved travel trajectory proves to be greater than the distance measured as a straight line, this error is increasingly reduced as the distance decreases, so at most this simplification has effects on the realism of the control of the travel of the fellow vehicle if the initially mentioned dynamic model is used.

The distance of the ego vehicle to the point of collision can be determined along a curved target trajectory, which in particular is specified to the simulation computer. This target trajectory can correspond to the center line of the lane of the real or even simulated road that is used, for example.

In an embodiment, even though the distance to the point of collision can be computed in the simulation computer using data of the simulated environment, nevertheless the computation can likewise be based on at least one driving parameter of the ego vehicle. In the case of a real vehicle, this can be the position measured in the real environment, which is transferred to the corresponding position in the simulated environment, for which purpose the at least one measured position value is transmitted to the simulation computer through a data input.

The simulated environment can be generated as a function of a real environment in which the real ego vehicle travels, in particular wherein the simulated environment, in particular a data set describing it, is loaded onto the simulation computer. For this purpose, the real test track can be digitized by acquiring measurement data from this real test track and loaded into the simulation computer, for example. Provision can be made that the ego vehicle itself measures the test track by driving the test track, and the test track is virtualized using the measurement data. The simulated environment, including the test track located therein, which reproduces a real test track, can also be created by modeling software and subsequently loaded into the simulation computer.

The target trajectory that is located on the simulated virtual test track in the simulated environment can be visualized for a driver who is driving the ego vehicle, for example on a screen or head-up display, so that the driver can compensate for any deviations therefrom by steering. Alternatively, instead of a visualization of the target trajectory, only information about possible deviations therefrom may be displayed to the driver.

In an exemplary embodiment, a driver may deviate from the target trajectory, in particular may not correct this error thereafter. In this case, provision can be made that the point of collision is updated in terms of its position. The subsequent computations of the simulation of the travel of the fellow vehicle can then be carried out with the updated point of collision instead of with the originally specified one. Updating of the point of collision can be carried out multiple times, in particular an update can be possible, and can if applicable also be carried out, in each cycle.

In the case of a simulated ego vehicle, the position of the gas pedal of the driving simulator can also constitute the driving parameter of the ego vehicle derived from the real world that is transferred into the simulation computer through a data interface in order to also compute the travel of the ego vehicle in the simulation computer and determine the position of or the distance to the point of collision using the simulated travel.

In general, all variant embodiments thus make provision that data, for example the geographical position data, in a real environment in which the real ego vehicle or its driving simulator is located, is acquired using real transducers or sensors and this data is transmitted to the simulation computer in order to determine therewith the position of the ego vehicle on the virtual test track or the distance of the ego vehicle to the point of collision.

In an embodiment in which an autopilot as a software implementation controls a real ego vehicle or a driving simulator, the same real measurement values are likewise acquired from the real world with transducers or sensors. In effect, the autopilot here merely replaces the human, but it operates the same vehicle components that a human would otherwise operate.

A last position of the fellow vehicle already reached on the trajectory of the fellow vehicle can be specified to the control loop as a limit position that must not be negatively exceeded, or the control loop specifies the speed to the fellow vehicle only in a range greater than or equal to zero. This achieves the result that the simulated vehicle does not travel backwards in the simulated travel, but instead always moves only toward the point of collision, at most standing still.

When the travel of the ego vehicle is also simulated, provision can generally be made that this simulation is computed on a simulation computer that is separate from the simulation computer of the fellow vehicle. In this case, the simulation of the fellow vehicle enriches the simulated travel of the ego vehicle with events or elements, in particular the appearance of the fellow vehicle in front of the ego vehicle, by the means that the simulation computer of the fellow vehicle supplies data to the inputs of the control unit of the driver assistance system in the simulation computer of the ego vehicle.

The same simulation computer can be used for simulating the travel of the ego vehicle and the travel of the fellow vehicle.

The control unit can be merely simulated in the simulation environment of the ego vehicle, so that the data inputs of the control unit are virtual.

Even in the case of simulated travel of the ego vehicle, a real control unit of the driver assistance system can be installed in the driving simulator, or in the simulation computer of the ego vehicle, or in both vehicles. Thus the driver assistance system under test is a real one, and only the automobile in which it is installed is virtual.

The driving parameters can be specified, as explained above, by a driving simulator that reproduces at least one control element of a vehicle in physical form, in particular a control element which is operated by a human or an autopilot.

In an exemplary embodiment, the travel of the ego vehicle is travel with a real vehicle, and a simulation computer is carried in the vehicle that generates the simulated environment and the fellow vehicle driving in this environment, wherein simulation data of the simulation computer is transmitted as simulated real data to the real control unit of the ego vehicle that controls the driver assistance system. The real vehicle is driven here by a human or is driven by a computer-controlled autopilot as a function of real environmental data acquired by measurement.

In order to obtain position data of a real ego vehicle in the real world by measurement, the invention provides that the position can be determined by means of differential satellite navigation, in particular to improve accuracy as compared to conventional satellite navigation.

To this end, the position of the ego vehicle measured with satellite navigation can be corrected by means of a reference whose position is known and whose position is likewise determined by the satellite navigation as well. This method of position determination is known under the name “differential GPS” or DGPS for short. The error ascertained here can be used to correct the error in the position of the ego vehicle. Regardless of the specific manner of acquisition, the real position data is transmitted as described above to the simulation computer to control the simulated travel of the fellow vehicle as a function of this real position data. For this purpose, virtual position data and/or consistent data, of the ego vehicle on the virtual, simulated test track or the target trajectory can be first determined from the real position data. The control of the travel of the fellow vehicle can then take place as a function of the virtual position data of the ego vehicle present in the simulated environment.

A speed control of the fellow vehicle can be switched off within a predefined spatial interval before the point of collision or within a predefined time interval before the time of collision, and the fellow vehicle continues simulated travel at the speed reached prior to switchoff or at the predefined arrival speed.

Alternatively, the invention can provide that in reaction to a response signal of the control unit under test of the ego vehicle, in particular in reaction to a response signal of an accident prevention assistant of the control unit implemented in software and/or hardware, the speed control of the fellow vehicle is switched off and the fellow vehicle continues simulated travel at the speed reached prior to switchoff or at the predefined arrival speed. The response signal can be sensed, e.g. at a signal output of the concrete driver assistance system control unit under test in order to make it available to the simulation computer. For example, an interrupt input of the simulation computer can be activated. Alternatively, a software branch condition can be generated by means of the response signal or the occurrence of the aforementioned interval condition, causing the speed control loop to be bypassed, but in particular the driving simulation is continued with the heretofore stored driving parameters.

The two measures prevent the control loop that determines the travel of the fellow vehicle from reacting in turn to a reaction of the driver assistance system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, is not limitive of the present invention, and wherein the sole figure illustrates an example embodiment, which represents an intersection where an actual collision is to be simulated between an ego vehicle and a fellow vehicle at a point of collision.

### DETAILED DESCRIPTION

The figure illustrates an intersection where an actual collision is to be simulated between an ego vehicle 1 and a fellow vehicle 2 at a point of collision KP. The figure illustrates the physical relationships here. The trajectories of ego vehicle 1 and fellow vehicle 2 each run in a center of a right-hand lane of a routing and meet, which is to say intersect, at the point of collision KP.

It is assumed that the two vehicles are each assigned their own location coordinate S1 or S2, which for each vehicle includes a zero position at a distance from the point of collision KP on the track segment traveled by the relevant vehicle at the position S1=0 for the ego vehicle or S2=0 for the fellow vehicle. From the point of view of the ego vehicle, the point of collision is located at a position S1_{KP} and from the point of view of the fellow vehicle it is located at a position S2_{KP}. The two vehicles start their respective travel at the zero positions, wherein according to the invention the travel of the fellow vehicle 2 is iteratively adapted to the travel of the ego vehicle 1.

Considered here is a situation in which the ego vehicle controlled by a human has already traveled a path. This path is Sᵥₑₕ₁ In doing so, the ego vehicle has a current speed Vᵥₑₕ₁, and a distance of ΔSᵥₑₕ₁ still remains to the point of collision KP.

In the control according to the invention, this situation exists in one specific control cycle out of many.

According to the formula shown in the figure, this results in a time Δt that the ego vehicle 1 still requires to arrive at the point of collision KP at the current speed Vᵥₑₕ₁.

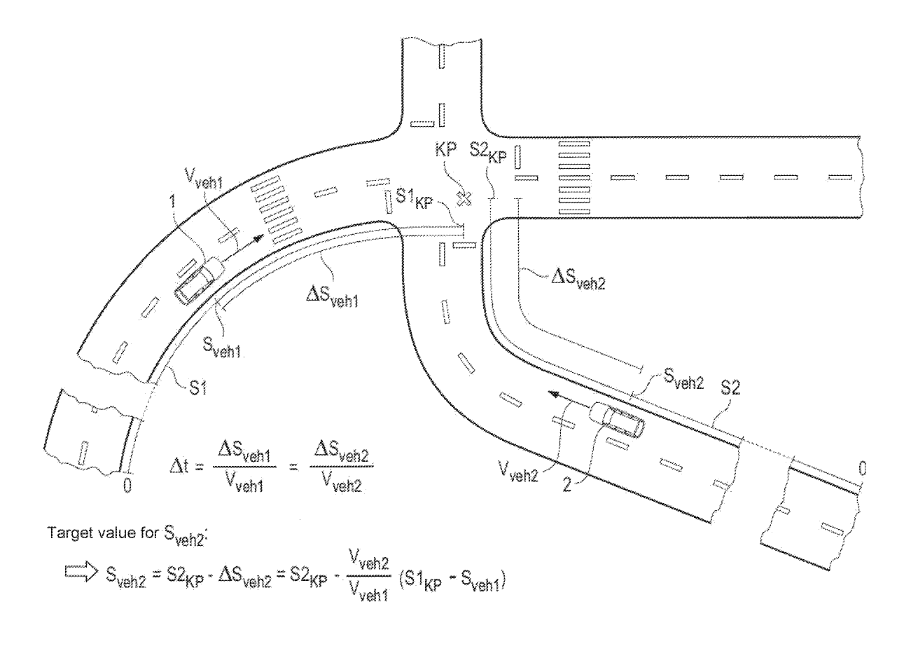

This same time should apply for the fellow vehicle in order for both vehicles to reach the point of collision KP simultaneously. In this regard it is specified that the fellow vehicle should arrive at the point of collision KP at the arrival speed Vᵥₑₕ₂. For this to be the case, the fellow vehicle would therefore have to have the target distance ΔSᵥₑₕ₂ to the point of collision KP, or have traveled the target path Sᵥₑₕ₂ relative to the starting point as viewed from its starting location S2. The target path Sᵥₑₕ₂ results from the time Δt according to the formula shown in FIG. 1.

In the simulation, the fellow vehicle has, for example, traveled a shorter path (not visualized) or still has a longer distance to the point of collision KP and is traveling at a speed that corresponds to the arrival speed or can also deviate from the arrival speed.

This distance and this position are accordingly specified to a control loop. This loop can correct the actual position to the target position or the actual distance to the target distance in a simple manner.

In a dynamic motion model of the fellow vehicle, in contrast, it is preferred that a new speed for the fellow vehicle is specified as the target speed for the next iteration cycle of the control in order to reduce the difference between target distance and actual distance or target position and actual position in the following cycle. In order to achieve this in the example cited, the control algorithm will accelerate the fellow vehicle in the simulation.

The target speed to be specified is a function of the current position of the fellow vehicle. In this regard, provision can be made that the target speed is determined in a higher-level control loop to which the current position is fed back.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for simulating a collision situation between two vehicles for testing a driver assistance system or a driver assistance system configured as a motor vehicle control unit, the method comprising:
assigning to a simulated fellow vehicle, in an environment simulated by a simulation computer, a trajectory on which the simulated fellow vehicle moves and which passes through a point of collision of a planned collision between the simulated fellow vehicle and an ego vehicle;
exchanging data between the driver assistance system and the simulated environment in real time, the driver assistance system being equipped to influence a driving behavior of the ego vehicle in a collision situation, the driving behavior including a braking maneuver or an evasive maneuver;
specifying an arrival speed to the simulated fellow vehicle at which it arrives or at least should arrive at the point of collision;
determining cyclically for each cycle, a position of the ego vehicle traveling under control or a distance to the point of collision and a current speed of the ego vehicle traveling under control or under unpredictable control, wherein the determination is accomplished by the simulation computer based on data of the simulated environment;
calculating for each cycle, a target position for the simulated fellow vehicle and/or a target distance by the simulation computer that the simulated fellow vehicle would have to have relative to the point of collision, wherein the simulated fellow vehicle travels at a specified arrival speed to arrive at the point of collision at a desired time or arrives at the point of collision simultaneously or substantially simultaneously with the ego vehicle; and
specifying the target position or the target distance of the simulated fellow vehicle to a control loop that controls the position of the simulated fellow vehicle along the trajectory, and a difference between the actual position and the target position or between the actual distance to the point of collision and the target distance is reduced by the control loop by changing the speed of the simulated fellow vehicle in a next cycle as compared to a previous cycle.

2. The method according to claim 1, wherein the change in the position and/or speed of the simulated fellow vehicle is carried out under the assumption that the simulated fellow vehicle has the mass zero.

3. The method according to claim 1, wherein the change in the speed of the simulated fellow vehicle is carried out in accordance with a dynamic mathematical model that takes real vehicle dynamics into account or takes into account a vehicle mass and an acceleration capability.

4. The method according to claim 1, wherein the position of the ego vehicle and/or the distance of the ego vehicle to the point of collision is determined along a curved target trajectory, which is specified to the simulation computer.

5. The method according to claim 1, wherein a last position of the simulated fellow vehicle already reached on the trajectory is specified to the control loop as a limit position that should not be negatively exceeded or wherein the control loop specifies the speed to the simulated fellow vehicle only in a range greater than or equal to zero.

6. The method according to claim 1, wherein the travel of the ego vehicle is simulated travel that is computed on the same simulation computer that governs the travel of the simulated fellow vehicle, and wherein the acceleration and direction of travel of the ego vehicle are specified by a driving simulator that reproduces at least one control element of a vehicle in physical form.

7. The method according to claim 1, wherein the travel of the ego vehicle is travel with a real vehicle and a simulation computer is carried in the vehicle, the simulation computer generating the simulated environment and the simulated fellow vehicle driving in the environment, and wherein simulation data of the simulation computer is transmitted as simulated real data to the real control unit of the ego vehicle that controls the driver assistance system.

8. The method according to claim 7, wherein the simulated environment is generated as a function of a real environment in which the real ego vehicle travels, and wherein the simulated environment or a data set describing the simulated environment is loaded onto the simulation computer.

9. The method according to claim 7, wherein the real ego vehicle is driven by a human or is driven by a computer-controlled autopilot as a function of real environmental data acquired by measurement.

10. The method according to claim 7, wherein the position data of the real ego vehicle is acquired in the real world by measurement or via differential satellite navigation, and wherein the real position data is transmitted to the simulation computer to control the simulated travel of the simulated fellow vehicle as a function of this real position data.

11. The method according to claim 1, wherein a speed control of the simulated fellow vehicle is switched off within a predefined spatial interval before the point of collision or within a predefined time interval before the time of collision, and wherein the simulated fellow vehicle continues simulated travel at the speed reached prior to switchoff or at a predefined arrival speed.

12. The method according to claim 1, wherein the speed control of the simulated fellow vehicle is switched off in reaction to a response signal of the control unit under test of the ego vehicle or in reaction to a response signal of an accident prevention assistant of the control unit implemented in software and/or hardware, and wherein the simulated fellow vehicle continues simulated travel at the speed reached prior to switchoff or at the predefined arrival speed.
